(19) United States
(12) Patent Application Publication
(10) Pub. No.: US 2013/0086794 A1
(43) Pub. Date: Apr. 11, 2013

(54) Nail Bundle

(71) Applicant: William Ralf Bond, Manassas, VA (US)

(72) Inventor: William Ralf Bond, Manassas, VA (US)

(21) Appl. No.: 13/200,875

(22) Filed: Oct. 5, 2011

(51) Int. Cl. F16B 15/08; B23P 11/00

(52) U.S. Cl. 29/525.08; 411/442; 29/525.11

(57) ABSTRACT

The present invention relates to a bundle of nails or screws whose pointed tips are secured in close proximity to each other by an adhesive or adhesive tape whereby each outer nail or screw from one end of the bundle can be manually separated from the bundle and subsequently readily driven or screwed into a work piece. Furthermore, any injurious effect to the carpenter or construction worker's hand is considerably reduced when obtaining the bundle of nails or screws from the hardware store or when handling and using the nails or screws at the work site.

### BACKGROUND OF THE INVENTION

1. Field of the Invention

The present invention relates to the use of bundles of construction nails to facilitate general carpentry or construction work using a hand held hammer but not an automatic nail hammering device.

2. Description of the Related Art

Generally, construction nails are supplied at a hardware store in cardboard boxes according to their sizes or in a tangled mess from bins containing different sized nails. This invention is concerned with the latter condition. A carpenter or construction worker, when a large number of nails are needed, he or she would go to a hardware store and pull handfuls of nails from a particular bin and put them in an appropriate bag. Subsequently, at the site where the work is to be done, the carpenter or construction worker would pull one or more handfuls of nails from the bag and put them in an appropriate pocket of his or her work apron. He or she would then reach into the appropriate pocket of his or her work apron and pull out a single sized nail to be singly hammered into a work piece. This latter process is time consuming and can also be injurious to the carpenter or construction worker when he or she reaches into the tangled mess of nails from one of the pockets of his or her work apron.

One prior art solution to the tangled mess of nails found in a keg or bin at the hardware store is disclosed in the Williams' patent U.S. Pat. No. 2,590,358. Williams discloses fixing a plurality of nails in packages wherein the nails are secured together by a support and subsequently removed from the support one by one as needed.

### SUMMARY OF THE INVENTION

The main purpose of this invention is to facilitate the hammering of nails one at a time by a hand held hammer into a work piece by bundling several nails together. Several nails, e.g., 3 to 6 nails (depending on their size), are bundled together in a substantially planar array by an adhesive or an adhesive tape near their pointed tips. An end nail can be manually angled from the nail bundle and singly hammered into a work piece by the carpenter or construction worker. Subsequently, the next succeeding nail in the nail bundle is then manually angled from the remaining nails in the nail bundle and hammered into the work piece and so forth.

It is an object of this invention to have bundles of nails available in bins at the hardware store so as not to provide such a tangled mess of nails when the nails are separately contained in the bins.

It is another object of this invention to lessen the occurrence of injury to the carpenter or construction worker's hand when pulling these nail bundles (rather than individual nails) from the hardware store bins or from the pockets in the work apron of the carpenter or construction worker.

It is a further object of this invention to pull nails from an apron pocket at a faster speed since the nails are bundled together rather than being individually distributed in the apron pocket in a tangled mess.

Other objects and advantages in the use of the nail bundles of this invention will become more apparent upon reading the following description of which the attached drawings form a part.

### BRIEF DESCRIPTION OF THE DRAWINGS

FIGS. 1-4 are front perspective views of four different sized bundled nails for a first embodiment of the present invention.

FIG. 5 is a front perspective view of bundled nails for a second embodiment of the present invention.

FIG. 6 is a front perspective view of a third embodiment of the present invention.

FIG. 7 is a front perspective view of bundled screws of the present invention.

FIG. 8 is an illustration showing how the present invention is used by a carpenter or construction worker.

### DETAILED DESCRIPTION OF THE PREFERRED EMBODIMENTS

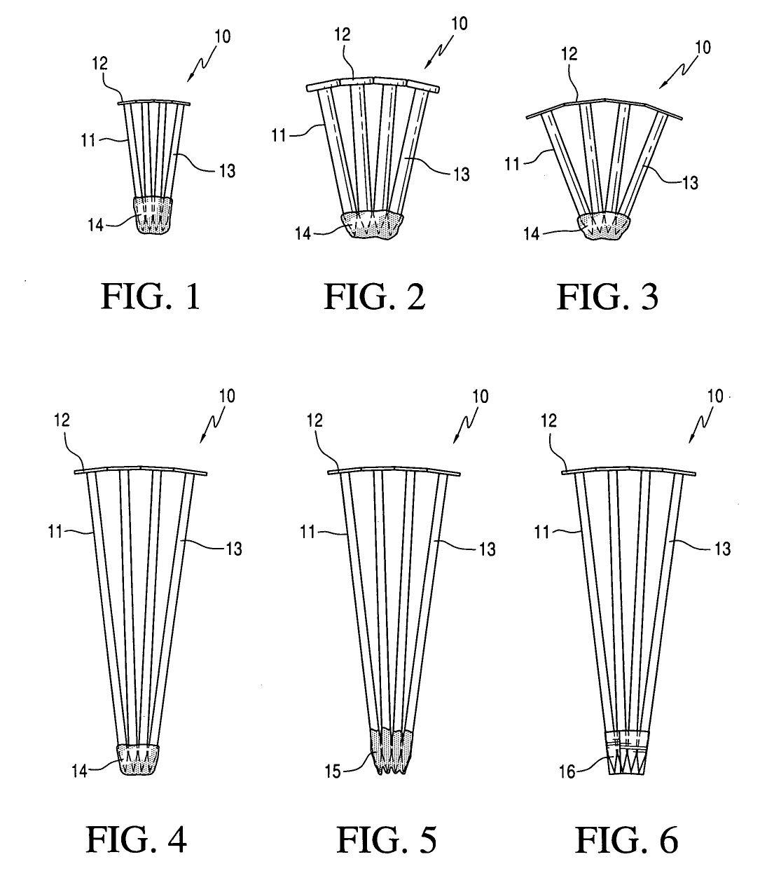

Referring to FIGS. 1-4, there are shown four bundles 10 of nails 11 wherein the nails 11 in each bundle 10 are of a different size. Each of the nails 11 in the bundles has the conventional head 12 and shank 13. In this embodiment, each bundle 10 of nails has their pointed tips in close proximity to each other and embedded in an adhesive 14 such as a fusible glue whereas the shanks 13 of the nails 11 in each bundle 10 fan outwardly from the pointed tips. The glue, for example, can be a hot melt glue made from a thermoplastic polymer dispensed from a hot glue gun. Other types of glue known in the art could also be used as the adhesive in the present invention. Furthermore, the nails 11 in each bundle 10 are aligned in a substantially planar array.

Referring to FIG. 5, there is shown another embodiment of the present invention wherein the pointed tips of the nails 11 in the bundle 10 are in close proximity to each other, as in the previous embodiment, but are secured together by an elastomeric adhesive 15 such as commercially available siliconized elastomeric liquid. The pointed tips of the bundle 10 of nails 11 can be brushed on with a liquid elastomeric adhesive or they can be dipped into a container of liquid elastomeric adhesive. As in the previous embodiment, the nails 11 in each bundle 10 fan outwardly from their pointed tips and the nails 11 in each bundle 10 are aligned in a substantially planar array.

Referring now to FIG. 6, there is shown a further embodiment of the present invention wherein the pointed tips of the nails 11 in the bundle 10 are in close proximity to each other, as in the previous embodiments, but are secured together by an adhesive tape 16 on one side or on opposite sides of the shanks 13. The adhesive tape 16 can be of the paper or textile type. As in the previous embodiments, the nails 11 in each bundle 10 fan outwardly from their pointed tips and the nails 11 in each bundle 10 are aligned in a substantially planar array.

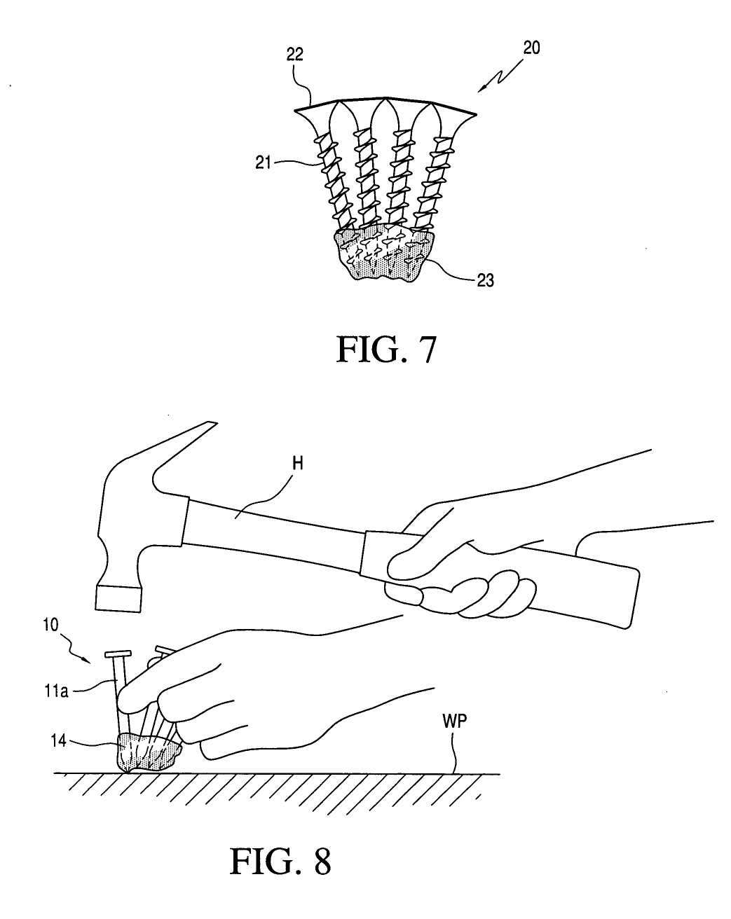

Referring now to FIG. 7, there is shown a bundle 20 of screws 21 to which the present invention can also be applied. Although the bundle 20 of screws 21 are shown secured to each other at their pointed tips (in a manner similar to the bundle of nails shown in FIGS. 1-5) by an adhesive 23 such as glue or an elastomeric adhesive they can also be secured together by an adhesive tape in a manner similar to that shown in FIG. 6.

Although the adhesives used in the embodiments of FIGS. 1-5 and FIG. 7 are strong enough to bind the several nails and screws together in a bundle they are frangible enough such that the separated nail or screw can readily break away from the bundle during use at the work site.

FIG. 8 illustrates how the present invention is used by a carpenter or construction worker. The illustration shown is directed to a bundle 10 of nails 11 using a hand held hammer H. The carpenter or construction worker would extract a particular bundle 10 of nails from, for example, the pocket of his or her work apron and with the fingers of one hand separate one of the end nails from the other nails in bundle 10 and hold the separated end nail 11a along with the other nails in the bundle 10 on the surface of the work piece WP and with a hammer H held in the opposite hand pound the separated end nail 11a into the work piece WP. Then, the carpenter or construction worker would repeat the same procedure for the next nail 11 in the bundle 10 and so forth as needed or until all the nails 11 in the bundle 10 have been used. In the case of a bundle 20 of screws 21, a somewhat similar manner would be applied using an appropriate sized screwdriver.

Modification of this invention will be readily apparent to those skilled in the art and it is intended that the invention be not limited by the embodiments disclosed herein but that the scope of the invention be defined by the appended claims.

What is claimed is:

1. A bundle of construction nails comprising several nails arranged in a juxtaposed position in a substantially planar array, said construction nails being attached together solely by an adhesive or adhesive tape on the shanks of said nails near or on the pointed tips of said nails.

2. The bundle of construction nails of claim 1 wherein the pointed tips of said construction nails are successively in close proximity to each other.

3. The bundle of construction nails of claim 1 wherein the pointed tips of said construction nails are in closer proximity to each other than the shanks of said nails near the heads of said nails.

4. The bundle of construction nails of claim 1 wherein said adhesive is an adhesive glue.

5. The bundle of construction nails of claim 1 wherein said adhesive tape is an adhesive paper or textile.

6. The bundle of construction nails of claim 1 wherein said adhesive is an elastomeric adhesive.

7. The bundle of construction nails of claim 1 wherein said adhesive tape is secured to one or both sides of the shanks of said construction nails.

8. A method of using the bundle of construction nails of claim 1 wherein a carpenter or construction worker:
selects a bundle of nails of a given size;
manually separates, with one hand, one of the end nails a given distance from the remainder of the nails in said bundle of nails without completely extracting said one end nail from said bundle;
holds said separated nail and said bundle of nails in said one hand against a work piece; and
drives said separated nail into said work piece with a hammer held in an opposite hand.

9. The method of claim 8 wherein said carpenter or construction worker:
repeats the steps in claim 8 with each succeeding nail in said bundle as needed or until all the nails in said bundle of nails are used.

10. A bundle of construction screws comprising several screws arranged in a juxtaposed position in a substantially planar array, said construction screws being attached together solely by an adhesive or adhesive tape on the shanks of said screws near or on the pointed tips of said screws.

11. The bundle of construction screws of claim 10 wherein the pointed tips of said construction screws are successively in close proximity to each other.

12. The bundle of construction screws of claim 10 wherein the pointed tips of said screws are in closer proximity to each other than the shanks of said screws near the heads of said screws.

13. The bundle of construction screws of claim 10 wherein said adhesive is an adhesive glue.

14. The bundle of construction screws of claim 10 wherein said adhesive tape is an adhesive paper or textile.

15. The bundle of construction screws of claim 10 wherein said adhesive is an elastomeric adhesive.

16. The bundle of construction screws of claim 10 wherein said adhesive tape is secured to one or both sides of the shanks of said construction screws.

17. A method of using the bundle of construction screws of claim 10 wherein a carpenter or construction worker:
selects a bundle of screws of a given size;
manually separates, with one hand, one of the end screws a given distance from the remainder of the screws in said bundle without completely extracting said one end screw from said bundle;
holds said separated screw and said bundle of screws in said one hand against a work piece; and
screws said separated screw into said work piece using a screwdriver in an opposite hand.

18. The method of claim 17 wherein the carpenter or construction worker:
repeats the steps in claim 17 with each succeeding screw in said bundle of screws as needed or until all the screws in said bundle of screws are used.
